(19) United States
(12) Patent Application Publication
(10) Pub. No.: US 2026/0021334 A1
(43) Pub. Date: Jan. 22, 2026

(54) DISASSEMBLABLE AND HEIGHT-ADJUSTABLE FRAME FOR SLACKLINES

(71) Applicant: Hubert Weymayer, Steyr (AT)

(72) Inventor: Hubert Weymayer, Steyr (AT)

(21) Appl. No.: 19/273,949

(22) Filed: Jul. 18, 2025

(30) Foreign Application Priority Data
Jul. 22, 2024 (AT) A60141/2024

(51) Int. Cl. A63B 7/08

(52) U.S. Cl. CPC A63B 7/085; A63B 2210/50; A63B 2225/093

(57) ABSTRACT

A disassemblable and height-adjustable frame for slacklines has a slackline support plate which rests on two upwardly converging carriers that are connected to a cross bar at the base by connecting elements. The carriers are rectangular-shaped telescopic tubes. The slackline support plate, which is downwardly open in a U-shape, rests on the upper end of the carriers. The upper end of the front side of the carrier has a convex curved shape on the material side starting from the carrier surface facing the carriers in the operating position, and at the upper end of the rear side of the carrier has a concave curved shape on the material side starting from the surface facing the carriers in the operating position, which merges into a straight line and then forms a convex curve shape.

### CROSS-REFERENCE TO RELATED APPLICATION

This application claims the priority, under 35 U.S.C. § 119, of Austrian Patent Application A 60141/2024, filed Jul. 22, 2024; the prior application is herewith incorporated by reference in its entirety.

### FIELD AND BACKGROUND OF THE INVENTION

The invention relates to a disassemblable and height-adjustable frame for slacklines, having a slackline support plate which rests on two upwardly converging carriers which are connected to a cross bar at the base by way of connecting elements,

The term “slackline” is the modern name for balancing straps that are usually attached between two trees at a low height. If no suitable trees are available, a slackline can also be mounted at other attachment points, such as ground anchors. This requires frames that hold the slackline at the same height above the ground so that there is sufficient height for balancing on the slackline and the person balancing in the middle of the slackline has no contact with the ground.

A pertinent such frame is disclosed in my earlier, published international patent application WO 2016/037203 A1. There, depending on the set height, the carriers protrude more or less far above the slackline support plate, which might represent a safety risk for the person balancing.

### SUMMARY OF THE INVENTION

It is accordingly an object of the invention to provide a frame for slacklines which overcomes the above-mentioned disadvantages of the heretofore-known devices and methods of this general type and which provides for a height-adjustable frame for slacklines which has no parts that protrude upwards above the slackline support plate, can be easily adjusted in height and at the same time the slackline support plate can always be adjusted horizontally even on slopes. In addition, the frame should be easy to disassemble and dismount to save space during transportation.

With the above and other objects in view there is provided, in accordance with the invention, a disassemblable and height-adjustable support frame for slacklines, the support frame comprising:
two carriers formed of telescopic tubes with a rectangular cross-section, said carriers being connected at a base thereof by way of a cross bar and converging upwardly towards an upper end thereof;
a slackline support plate resting on said upper end of said carriers, said slackline support plate being downwardly open in a U-shape with downwardly projecting vertical webs;
an upper end of a front side of each of said carriers having a convex-curved shape on a material side starting from a carrier surface facing towards an opposite said carrier in an operating position
an upper end of a rear side of each of said carriers having a concave-curved shape on a material side starting from said carrier surface facing towards an opposite said carrier in the operating position, said concave-curved shape merging into a straight line and then forming a convex-curved shape on the material side downwards in a direction of said carrier surface of the opposite said carrier;
wherein, in the operating position of said carriers, said convex-curved shapes on the carrier front side reach into said concave curve shape on the carrier rear side of the opposite said carrier, and said convex-curved shape on the carrier rear side lies tangentially against a facing carrier surface of the opposite said carrier and a recess is formed on said facing carrier surface facing each other from the carrier rear side to at least a central longitudinal axis of said carrier surfaces that face each other and which reach into each other in the operating position of said carriers; and
said carriers being formed with bearing bores in alignment with two spaced-apart bearing bores formed in said vertical webs of said downwardly U-shaped slackline support plate for receiving said bearing elements, and wherein said carriers are pivotably connected to said slackline support plate by way of said bearing elements.

In other words, the objects of the invention are achieved in that the carriers are designed as rectangular (in cross-section) telescopic tubes, and that a slackline support plate rests on the upper end of these carriers, with the slackline support being open downwards in a U-shape, and the upper end of the front side of the carrier has a convex curved shape on the material side starting from the carrier surface facing the carriers in the operating position, and at the upper end of the rear side of the carrier has a concave curved shape on the material side starting from the surface facing the carriers in the operating position, which merges into a straight line and then forms a convex curve shape on the material side downwards in the direction of the carrier surface of the carrier facing one another in the operating position, wherein, in the operating position of the carriers, the convex curve shape on the material side at the upper end of the carrier front side reach into each others with the concave curve shape on the material side at the upper end of the carrier rear side of the opposite carrier, and in operating position the convex curve shape on the material side at the upper end of the carrier rear side, lies tangentially against the facing carrier surface of the opposite carrier, and a recess is formed on the carrier surface of the carrier facing each other in operating position from the carrier rear side of the carrier to at least until the central longitudinal axis of the carrier surface facing each other in operating position, which reach into each other in the operating position of the carriers, and in that the carriers have bearing bores, which are arranged in alignment with two spaced-apart bearing bores on the vertical webs of the U-shaped downwardly open slackline support plate for receiving the bearing elements, wherein the carriers are pivotably connected to the slackline support plate by way of the bearing elements.

This type of frame enables quick and easy height adjustment and adaptation to slopes using telescopic carriers. The convex curve shape on the material side at the upper end of the carrier front side reach into each others with the concave curve shape on the material side at the upper end of the carrier rear side of the opposite carrier in the operating position, which has the surprising effect that when a carrier is rotated by a certain amount of angle around its bearing bore, the opposite carrier automatically rotates by the same amount of angle in the opposite direction. In other words, the carriers are prevented from moving freely along their longitudinal axis, which means that the slackline support plate can no longer change its angle despite having two movable bearing points and therefore always assumes a symmetrical angle between the two carriers. This means that the belt support surface is always horizontal on horizontal installation surfaces; on slopes, the slackline support plate can be adjusted to be as horizontal as possible by telescoping the carriers asymmetrically.

In addition, the convex curve shape of the back of the carrier on the material side lays on tangential on the opposite carrier, which has the effect of additionally restricting the freedom of movement of the carriers along their longitudinal axis and holding the slackline support plate even more precisely at a symmetrical angle between the carriers. The angle of the straight line that connects the concave and the convex curve shape on the back of the carrier determines the maximum angle of spread of the carrier 4 in the operating position and thus forms an end stop. With a maximum carrier spread angle of 90°, for example, the straight line is normal (i.e., perpendicular) to the longitudinal axis of the carrier. The fact that the different curve shapes are placed in opposite directions on the front and rear sides of the carriers further reduces any play between the curve shapes that reach into each other. Further the carrier surfaces facing each other in operating position tangentially lay on to the convex curve shape of the opposite carrier rear site, which makes it even more precise to maintain the symmetrical angle. The opposing recesses on the end faces of the carriers ensure that the carriers surfaces facing one another can be pushed into each other when the carriers get folded apart

In accordance with an added feature of the invention, on the carrier surfaces of the carriers which face each other in the operating position is a web reaching from its centrally running longitudinal axis to the front side of the carrier.

The positive effect of opposing, offset webs are formed on the facing surface of the carriers in operation position is a centering of the carriers centrally under the slackline support plate and holding them in position.

In accordance with an additional feature of the invention, the rear side of the carriers at the upper end forms bearing points for the slackline support plate in form of a straight bearing surface running normal to the longitudinal axis of the carriers, which extends from the carrier surface facing the carriers in the operating position and, from the extended longitudinal axis of the carrier extending through the center of the bearing bore of the carrier merges outwards into a convex arcuate section on the material side, the radius of which extends from the center of the bearing bore of the carrier.

The positive effect of this is that when the frame is folded together at a 0° splay angle of the carriers, the straight bearing surface on the upper end face of the carriers rests on the lower edge of the support plate, the carriers can hardly be moved against each other in longitudinal direction and this makes it easier for the opposing convex and concave curves at the upper ends of the carriers to reach into each other. As soon as the carriers are in the operating position with a splay angle greater than 0°, bearing points are formed between the convex arc of the carrier end faces on the material side and the slackline support plate. This has the positive effect that the forces of the slackline are transferred via the slackline support plate directly to the carriers, in addition to the bearing elements. Furthermore, this further reduces any possible play between carrier and slackline support plate and thus stabilizes the slackline support plate even better and more precisely at a symmetrical angle between the carriers or in a horizontal position.

According to a further advantageous variant of the invention, the carrier surfaces facing each other in the operating position have a nose formed above the recess, which projects 10°-45° in the direction of the web of the opposite carrier in the operating position.

The positive effect is that when the frame is folded together at a 0° spread angle of the carriers, this nose projecting 10°-45° in the direction of the opposite carrier is guided over the web of the opposite carrier and thus reliably prevents displacement along the longitudinal axis of the adjacent carriers in both directions and thus ensures that the convex curve of the front side of the carrier snaps securely into the concave curve shape of the rear side of the carrier when the carriers are spread out into the operating position.

It is a further advantageous embodiment of the invention that the slackline support plate has lateral stops for the slackline in the form of cylinder head screws.

This has the advantage that the resting slackline cannot slip off the slackline support plate, especially in the event of strong lateral vibrations of the slackline, as can typically occur when balancing. The round head shape of cylinder head screws protects the slackline against chafing at its lateral edges.

In accordance with a further feature of the invention, the coordinates for the material-side concave curve formed at the upper end of the rear side of the carrier are determined by the parameter representation P(x,y)

$$x = A - \sqrt{( 5 {A}^{2} + {B}^{2} - 4 A \sqrt{{A}^{2} + {B}^{2} ) * cos [ atan ( \frac{B}{A} ) - a ] )}} * cos [ atan ( \frac{sin [ atan ( \frac{B}{A} ) - a ]}{\frac{2 A}{\sqrt{{A}^{2} + {B}^{2} )}} - cos [ atan ( \frac{B}{A} ) - a ]} ) + a ]$$

$$y = \sqrt{( 5 {A}^{2} + {B}^{2} - 4 A \sqrt{{A}^{2} + {B}^{2} ) * cos [ atan ( \frac{B}{A} ) - a ] )}} * sin [ atan ( \frac{sin [ atan ( \frac{B}{A} ) - a ]}{\frac{2 A}{\sqrt{{A}^{2} + {B}^{2} )}} - cos [ atan ( \frac{B}{A} ) - a ]} ) + a ]$$

where α is one half of the angle of inclination of the carriers relative to one another, A is half the distance between the bearing bores of the slackline support plate and B is the distance between the bearing bore of the carrier and the design height of the start of the curve of the concave curve shape of the rear side of the carrier, and the coordinate zero point P(0,0), with (x=0, y=0) is located halfway between the spaced bearing bores of the support plate.

The surprising effect is that with the shaping by the above-mentioned formulas of the parameter representation, an exact reach into each other of the convex curve shape on the front side of the carrier with the concave curve shape on the rear side of the carrier makes it possible to create an exact symmetrical angle of the slackline support plate between the carriers in the first place.

In accordance with a concomitant feature of the invention, the convex curve formed on the material side at the upper end of the carrier front side has a curve part in the upper 45°-segment of the curve, which is formed by a horizontal reflection of the upper 45°-segment of the material-side concave curve part of the material-side concave curve of the carrier rear side about a vertical axis, and the convex curve formed on the material side at the upper end of the carrier front side has a curve part in the lower 45°-segment of the curve, which is formed by the downward reflection of the upper curve part of the curve about a 45° axis which has its origin on the carrier surface facing said carriers in the operating position at a level of a lower end point of said concave-curved shape formed on the rear side of said carrier surface.

The advantage of a smaller clearance between the reach into each other material-side convex curve shape of the front side of the carrier and the material-side concave curve shape of the rear side of the carrier arises from the fact that the upper 45°-section of the material-side convex curve shape of the front side of the carrier represents a vertical reflection of the upper 45°-section of the material-side concave curve shape on the rear side of the carrier, and the lower 45°-section of the material-side convex curve shape of the front side of the carrier is formed by a vertical and horizontal reflection of the upper 45°-section of the material-side concave curve shape on the rear side of the carrier. The convex curve shape of the front side of the carrier can also be formed by simpler radius or other geometric shapes that fit into the concave curve shape of the rear side of the carrier on the material side, whereby the contact surfaces become smaller and a larger clearance can occur.

Other features which are considered as characteristic for the invention are set forth in the appended claims.

Although the invention is illustrated and described herein as embodied in a dismountable and height-adjustable frame for slacklines, it is nevertheless not intended to be limited to the details shown, since various modifications and structural changes may be made therein without departing from the spirit of the invention and within the scope and range of equivalents of the claims.

The construction and method of operation of the invention, however, together with additional objects and advantages thereof will be best understood from the following description of specific embodiments when read in connection with the accompanying drawings.

### BRIEF DESCRIPTION OF THE FIGURES

FIG. 1: Schematic perspective view of the frame according to the invention with slackline.

FIG. 2: An elevation of the frame according to the invention at various telescopic support heights and inclinations.

FIG. 3: Perspective view of the frame according to the invention in a disassembled state after removal of the connecting elements between the carriers and the cross bar.

FIG. 4: Perspective view of the upper end of the carrier according to the invention.

FIG. 5: The upper end of the front of the carrier according to the invention in elevation.

FIG. 6: The upper end of the rear side of the carrier according to the invention in elevation.

FIG. 7: Elevation of the upper end of the carrier side facing each other in the operating position according to the invention.

FIG. 8: Schematic view of the curves, according to the invention at the upper end of the carriers reach into each other at 60° operating position.

FIG. 9: Schematic view of the curves, according to the invention at the upper end of the carriers position, when reach into each other at 90° operating position.

FIG. 10: Perspective view of the upper end of the carrier according to the invention.

FIG. 11: The upper ends of the carriers according to the invention in plan view at approx. 30° operating position.

FIG. 12: The upper ends of the carriers with slackline support plate according to the invention in side view at approx. 60° operating position.

FIG. 13: Perspective view of the slackline support plate according to the invention.

FIG. 14: Perspective view of the slackline support plate according to the invention with carriers in the operating position.

FIG. 15: The slackline support plate according to the invention in longitudinal section with the upper ends of the carriers in the operating position in elevation.

FIG. 16: The upper ends of the carriers according to the invention in elevation.

FIG. 17: The upper ends of the carriers according to the invention with protruding nose in elevation.

FIG. 18: Plan view of the upper end of the support with protruding nose according to the invention.

FIG. 19: Plan view of the upper ends of the carriers according to the invention with projecting nose at 0° splay angle.

FIG. 20: Perspective view of the slackline support plate according to the invention with lateral stops.

FIG. 21: Schematic view of the curves according to the invention with calculation data.

FIG. 22: Schematic view of the curves according to the invention.

FIG. 23: Schematic view of the curves at the upper end of the carriers according to the invention in elevation.

FIG. 24A: Schematic view of the curves according to the invention at the upper end of the carriers folded in elevation.

FIG. 24B: Schematic view of the curves according to the invention at the upper end of the carriers reach into each other in the operating position 60° in elevation.

FIG. 24C: Schematic view of the curves according to the invention at the upper end of the carriers reach into each other in the 90° operating position in elevation.

### DETAILED DESCRIPTION OF THE INVENTION

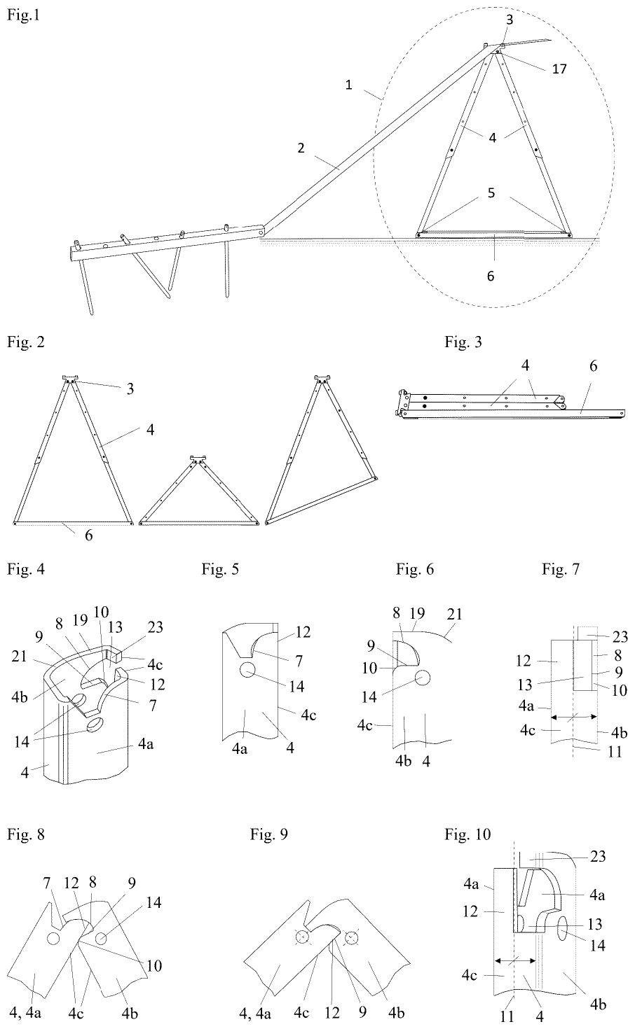

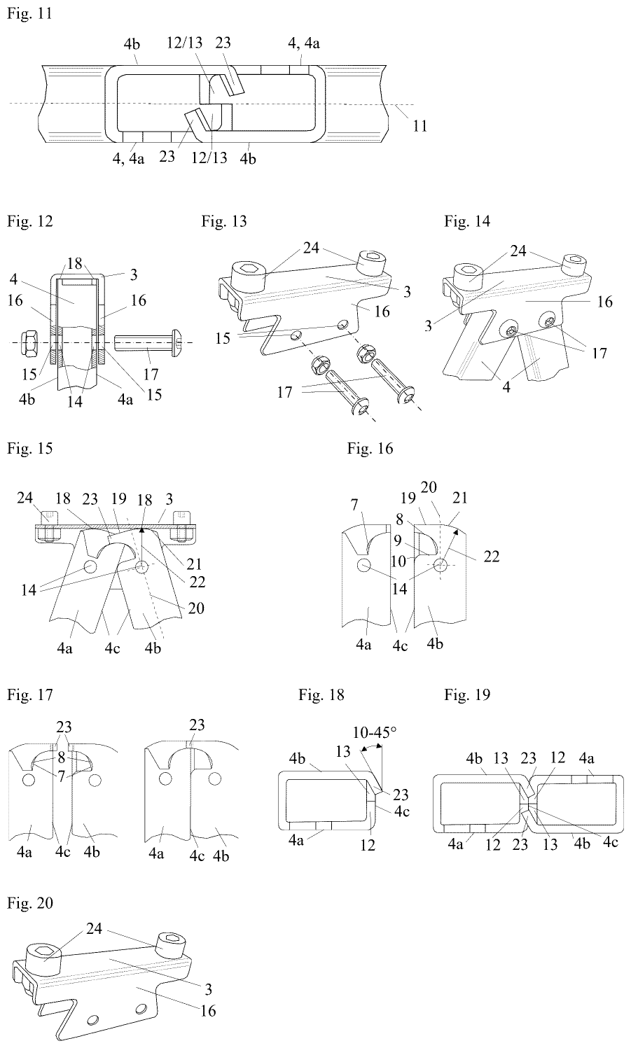

FIG. 1 shows a schematic view of a support frame 1 for slacklines 2. The frame 1 can be dismantled and is adjustable in height in accordance with the invention. The frame 1 has a U-shaped slackline support plate 3 which is open at the bottom and rests on two telescopic carriers 4 which converge at the top in an A-shape and are connected to the slackline support plate 3 by bearing elements 17 and to a cross bar 6 at the bottom by connecting elements 5. A slackline 2 is supported by the frame 1.

FIG. 2 shows an elevation of the frame 1 according to the invention with two different support heights set by symmetrical telescoping of the carriers 4 and a slope inclination set by asymmetrical telescoping of the carriers 4.

FIG. 3 shows a perspective view of the frame 1 according to the invention in a dismantled state after removal of the connecting elements 5 between the carriers 4 and the cross bar 6.

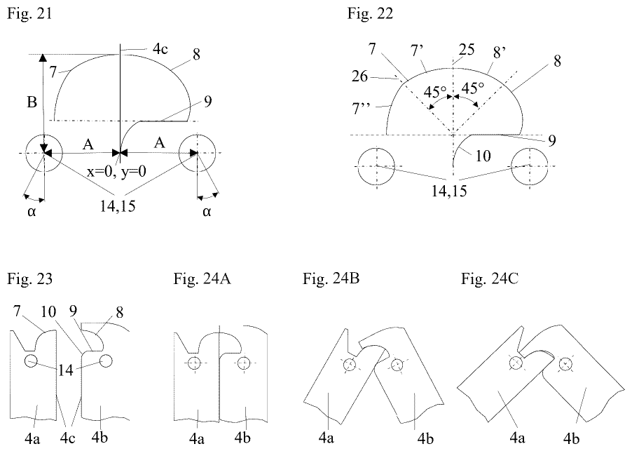

FIG. 4 shows the upper ends of the carriers 4 according to the invention in perspective with the carrier front side 4a in the foreground. It shows on the upper front side 4a of the carrier the convex curved shape 7 starting on the side surface 4c, and on the rear side 4b of the carrier with the concave curved shape 8 starting on the side surface 4c, which merges into a straight line 9, which opens into a convex curved shape 10 on the downward side, which ends on the side surface 4c. The front side 4a and the rear side 4b of the carrier 4 have an aligned bearing bore 14. Also visible at the upper end of the rear side 4b of the carrier 4 is the straight bearing surface 19, which merges into a convex circular arc 21 on the material side. On the side surface 4c, a nose 23 extending from the back of the carrier 4b with the recess 13 underneath can be seen, and a web 12 extending from the front of the carrier 4a is also visible on the same side surface 4c.

FIG. 5 illustrates the upper end of the carrier front side 4a according to the invention in elevation with the convex curve shape 7 beginning on the material side of the carrier side 4c facing the carrier in the operating position.

FIG. 6 shows the upper end of the carrier rear side 4b according to the invention in elevation with the concave curve shape 8 beginning on the carrier side 4c facing the carrier in the operating position, which merges into a straight line 9 which in turn leads into a convex curve shape on the material side downwards in the direction of carrier side 4c.

FIG. 7 illustrates the upper end of the carrier 4 according to the invention in elevation with the carrier side 4c facing each other in the operating position in the foreground with the longitudinal axis 11 running centrally on this carrier surface 4c, on this longitudinal axis there is a web 12 in the direction of the carrier front side 4a, and along the same longitudinal axis 11 there is an opposing recess 13 in the direction of the carrier rear side 4b.

FIG. 8 schematically shows the curve shapes 7, 8 and 10 according to the invention at the upper ends of the carriers 4 reach into each other at 60° operating position. The convex curve shape 7 on the front side of the carrier 4a reach into each others with the concave curve shape 8 on the rear side of the carrier 4b. At the same time, the carrier surface 4c lies tangentially against the convex curve 10 of the rear side of the carrier 4b.

FIG. 9 schematically illustrates the curve shapes 7, 8 and 10 according to the invention at the upper ends of the carrier 4 reach into each other at 90° operating position. In this operating position, the web 12 of the support surface 4c of the carrier 4 lies flat on the straight bearing surface 9 of the rear side of the support 4b and thus forms an end stop.

FIG. 10 shows a perspective view of the upper end of the carrier 4 according to the invention with the rear side of the carrier 4b and the lateral carrier surface 4c in the foreground, with the longitudinal axis 11 running in the center of the lateral carrier surface 4c. The web 12 according to the invention is formed from the centered longitudinal axis 11 in the direction of the front side of the carrier 4a. On the other side of the longitudinal axis 11, a recess 13 is formed in the opposite direction towards the rear side of the carrier 4b. Above the recess 13, a nose 23 can be seen at the uppermost end of the side surface 4c.

FIG. 11 illustrates the upper ends of the carriers 4 according to the invention in plan view with two carriers 4 reached into each other at an operating position of approximately 30°. The web 12, which extends in each case from the carrier side 4a to the longitudinal axis 11, engages in each case in the opposite recess 13, which extends in the opposite carrier 4 from its rear side 4b to the longitudinal axis 11. The 10°-45° nose 23 projecting and bent outwards into the respective opposite carrier 4 can also be seen.

FIG. 12 shows the upper ends of the carriers 4 with slackline support plate 3 according to the invention in side view at approx. 60° operating position. The bearing openings 15 on the lateral webs 16 of the slackline support plate 3 are aligned with the bearing openings 14 of the upper end of the carriers 4, the bearing element 17 enables a swiveling connection between the slackline support plate 3 and the carriers 4. Furthermore, the bearing points 18 of the rear sides 4b of the carriers 4 are shown on the underside of the slackline support plate 3.

FIG. 13 illustrates the slackline support plate 3 according to the invention in perspective with two spaced bearing openings 15 on the lateral webs 16 and the bearing elements 17.

FIG. 14 shows a perspective view of the slackline support plate 3 according to the invention with carriers 4 in the 60° operating position. The carriers 4 are pivotably connected by means of bearing elements 17 to the slackline support plate 3, which is at a symmetrical angle to the carriers 4.

FIG. 15 illustrates the slackline support plate 3 according to the invention in longitudinal section with the upper ends of the carriers 4 in operating position 30° in elevation. At the upper end of the rear side of the carrier 4b there is a straight bearing surface 19 which is normal to the longitudinal axis 20 of the carrier 4, the straight bearing surface 19 merges from the upwardly extended longitudinal axis 20 running through the center of the bearing opening 14 of the carrier 4 into a convex circular arc section 21 on the material side, which corresponds to the radius 22 in length from the center of the bearing opening 14 of the carrier 4 along the longitudinal axis 20 to the straight bearing surface 19. In the operating position 30° shown, one point of the circular arc piece 21 forms a bearing point 18 on the slackline support plate 3.

FIG. 16 shows the upper ends of the carriers 4 according to the invention in elevation, on the left the carrier front side 4a with the convex curve shape 7 on the material side in the foreground, and on the right the carrier rear side 4b with the concave curve shape 8 on the material side in the foreground. In the foreground, the rear side 4b of the carrier 4 shows a straight bearing surface 19 at the upper end of the support 4, which is right angled to the longitudinal axis 20 of the carrier 4 and which, from the longitudinal axis 20 running through the center of the bearing opening 14, merges into a convex circular arc 21 on the material side, the radius 22 of which starts from the center of the bearing opening 14.

FIG. 17 illustrates the upper ends of the carriers 4 according to the invention facing each other with projecting nose 23 in elevation, once individually with the carrier front side 4a and the carrier rear side 4b in the foreground, and once in the folded position with 0° splay angle between the carriers 4. At the upper end of the side surface 4c, the noses 23 protruding towards the opposite carriers 4 are recognizable in each case.

FIG. 18 shows the upper end of the carrier 4 with the nose 23 according to the invention in plan view, with the nose 23 starting from the rear side 4b of the carrier and projecting outwards by 10-45° on the side surface 4c of the carrier.

FIG. 19 illustrates the upper ends of the carriers 4 according to the invention with projecting nose 23 at 0° splay angle of the carriers 4 in plan view. The protrusion of the noses 23 over the web 12 of the respective opposite carrier 4 can be seen.

FIG. 20 shows a perspective view of the slackline support plate 3 according to the invention with lateral stops 24 in the form of cylinder head screws.

FIG. 21 schematically illustrates the curves 7 and 8 according to the invention with the calculation data A for the half distance between the centers of the spaced bearing bores 15 of the support plate 3 or the distance between the center of the bearing bore 14 of the carrier 4 and the carrier surface 4c of the carrier 4, B for the distance from the center of the bearing bore 14 of the carrier 4 to the design height of the start of the concave curve shape 8 on the side surface 4c of the carrier 4, as well as the variable positioning angle α of the carrier 4. The coordinate zero point (x=0, y=0) is located halfway between the spaced bearing bores 15 of the support plate 3.

FIG. 22 schematically shows the curves 7 and 8 according to the invention with a vertical axis 25, which separates the curves 7 and 8, and a 45° axis 26, which separates the curve 7 into an upper curve part 7′ and a lower curve part 7″, as well as a 45° axis which delimits the upper curve part 8″ of the curve 8. The axis 25 runs vertically in the center between the bearing bores 14 of two facing carriers 4 in the 0° operating position, the two 45° axes originate on the vertical axis 25 at the level of the lower end point of the curve 8. The curve section 7′ is a horizontal reflection of the curve section 8′ around the vertical axis 25. The curve section 7″ is a reflection of the curve section 7′ around the 45° axis 26.

FIG. 23 schematically illustrates the curves 7, 8 and 10 according to the invention at the upper end of the carriers 4 in a simplified form in elevation with the convex curve shapes 7 of the front side 4a of the carrier 4 on the material side and on the rear side 4b of the carrier 4 with the concave curve shape 8 and the convex curve shape 10 on the material side, both of which are connected by a straight line 9.

FIG. 24A schematically shows the curves 7, 8 and 10 according to the invention at the upper end of the carriers 4 folded together at a 0° angle of spread of the carriers 4 in a simplified form in elevation, and serves only to illustrate the reaching into each others of the curve shapes.

FIG. 24B schematically illustrates the curves 7, 8 and 10 according to the invention at the upper end of the carriers 4 reach into each other in the operating position at a 60° angle of spread of the carriers 4 in a simplified form in elevation, and serves only to illustrate the reaching into each others of the curve shapes.

FIG. 24C schematically shows the curves 7, 8 and 10 according to the invention at the upper end of the carriers 4 reach into each other in the operating position at a 90° angle of spread of the carriers 4 in simplified form in elevation, and serves only to illustrate the reaching into each other of the curve shapes as well as the representation of the stop at the spread angle of the carrier 4.

1. A support frame for slacklines, the support frame comprising:
two carriers formed of telescopic tubes with a rectangular cross-section, said carriers being connected at a base thereof by way of a cross bar and converging upwardly towards an upper end thereof;
a slackline support plate resting on said upper end of said carriers, said slackline support plate being downwardly open in a U-shape with downwardly projecting vertical webs;
an upper end of a front side of each of said carriers having a convex-curved shape on a material side starting from a carrier surface facing towards an opposite said carrier in an operating position
an upper end of a rear side of each of said carriers having a concave-curved shape on a material side starting from said carrier surface facing towards an opposite said carrier in the operating position, said concave-curved shape merging into a straight line and then forming a convex-curved shape on the material side downwards in a direction of said carrier surface of the opposite said carrier;
wherein, in the operating position of said carriers, said convex-curved shape on the carrier front side reach into said concave curve shape on the carrier rear side of the opposite said carrier, and said convex-curved shape on the carrier rear side lies tangentially against a facing carrier surface of the opposite said carrier; and
wherein a recess is formed on said facing carrier surface facing each other from the carrier rear side to at least a central longitudinal axis of said carrier surfaces that face each other and which reach into each other in the operating position of said carriers; and
said carriers being formed with bearing bores in alignment with two spaced-apart bearing bores formed in said vertical webs of said downwardly U-shaped slackline support plate for receiving said bearing elements, and wherein said carriers are pivotably connected to said slackline support plate by way of said bearing elements.

2. The support frame according to claim 1, which comprises a web formed on the carrier surfaces of said carriers which face each other in the operating position, said web extending from said central longitudinal axis to the front side of said carrier.

3. The support frame according to claim 1, wherein said carrier rear side of said carriers at the upper end forms bearing points for said slackline support plate in form of a straight bearing surface running perpendicular to the longitudinal axis of said carriers, said straight bearing surface extending from said carrier surface facing said carriers in the operating position and, from an extended longitudinal axis of said carrier extending through a center of said bearing bore of said carrier, merges outwards into a convex arcuate section on the material side, and a radius of which extends from the center of the bearing bore of said carrier.

4. The support frame according to claim 1, wherein said carrier surfaces of said carriers that face each other in the operating position are formed with a nose above said recess, and said nose projects 10-45° in a direction of a web of the respectively opposite carrier.

5. The support frame according to claim 1, wherein said slackline support plate comprises lateral stops for a slackline, said lateral stops being cylinder head screws.

6. The support frame according to claim 1, wherein coordinates for the material-side concave curve formed at the upper end of the rear side of the carrier are defined by the parameter representation P(x,y)
$$x = A - \sqrt{( 5 {A}^{2} + {B}^{2} - 4 A \sqrt{{A}^{2} + {B}^{2} ) * cos [ atan ( \frac{B}{A} ) - a ] )}} * cos [ atan ( \frac{sin [ atan ( \frac{B}{A} ) - a ]}{\frac{2 A}{\sqrt{{A}^{2} + {B}^{2} )}} - cos [ atan ( \frac{B}{A} ) - a ]} ) + a ]$$
$$y = \sqrt{( 5 {A}^{2} + {B}^{2} - 4 A \sqrt{{A}^{2} + {B}^{2} ) * cos [ atan ( \frac{B}{A} ) - a ] )}} * sin [ atan ( \frac{sin [ atan ( \frac{B}{A} ) - a ]}{\frac{2 A}{\sqrt{{A}^{2} + {B}^{2} )}} - cos [ atan ( \frac{B}{A} ) - a ]} ) + a ]$$
where α is one half of an angle of inclination of the carriers relative to one another, A is one half a distance between said bearing bores of said slackline support plate, and B is a distance between said bearing bore of said carrier and a design height of a start of the curve of the concave-curved shape of the rear side of said carrier, and a coordinate zero point is located halfway between the spaced-apart bearing bores of said slackline support plate.

7. The support frame according to claim 1, wherein said convex curve formed on the material side at the upper end of the carrier front side has a curve part in an upper 45°-segment of the curve, which is formed by a horizontal reflection of an upper 45°-segment of the material-side concave curve part of the material-side concave curve of the carrier rear side about a vertical axis, and said convex curve formed on the material side at the upper end of the carrier front side has a curve part in a lower 45°-segment of the curve, which is formed by a downward reflection of the upper curve part of the curve about a 45° axis which has its origin on the carrier surface facing said carriers in the operating position at a level of a lower end point of said concave-curved shape formed on the rear side of said carrier surface.
